(19) United States
(12) Patent Application Publication
(10) Pub. No.: US 2012/0287233 A1
(43) Pub. Date: Nov. 15, 2012

(54) PERSONALIZING 3DTV VIEWING EXPERIENCE

(76) Inventors: Haohong Wang, San Jose, CA (US); Glenn Adler, Redwood City, CA (US)

(21) Appl. No.: 13/519,565

(22) PCT Filed: Dec. 29, 2009
(86) PCT No.: PCT/US2009/069704

§ 371 Date: Jun. 27, 2012

(51) Int. Cl. H04N 13/00

(52) U.S. Cl. 348/42; 348/E13.003

(57) ABSTRACT

A method for personalized video depth adjustment includes receiving a video frame, obtaining a frame depth map based on the video frame, and determining content genre of the video frame by classifying content of the video frame into one or more categories. The method also includes identifying a user viewing the video frame, retrieving depth preference information for the user from a user database, and deriving depth adjustment parameters based on the content genre and the depth preference information for the user. The method further includes adjusting the frame depth map based on the depth adjustment parameters, and providing a 3D video frame for display at a real-time playback rate on a user device of the user. The 3D video frame is generated based on the adjusted frame depth map.

### TECHNICAL FIELD

The present disclosure relates to methods and systems for personalizing 3DTV viewing experience.

### BACKGROUND

Nowadays the consumption of digital media has been changed rapidly from the typical “TV in the living room” to ubiquitous access. A typical home entertainment system may now contain more than one TV, and the scope also extends to PCs and mobile TV systems such as mobile phones, PDAs, and portable players. Various efforts have been made to provide a user with capabilities to personalize the multimedia content according to the user's preferences. Personalization enables the user to access the multimedia content seamlessly with various devices and networks. Further, seamless user experiences can be provided despite varying device and network characteristics.

An example of prior art content adaptability and personalization using MPEG-7 and MPEG-21 standards is disclosed in B. L. Tseng, C. Y. Lin and J. R. Smith, Using MPEG-7 and MPEG-21 for Personalizing Video, IEEE Multimedia, January-March 2004. MPEG-7 is a multimedia metadata description standard to allow searching for material that is of interest to users. MPEG-21 is a rights repressions standard that defines a multimedia framework to enable transparent and augmented use of multimedia resources across a range of networks and devices used by different communities. In the MPEG-7 standard, a user preference can be described, and in the MPEG-21 standard, a usage environment can be specified with user profiles, terminal properties, and network characteristics. As an example, a user agent profile in the wireless access protocol (WAP) specifies a device profile that covers software and hardware platforms, browser information, and network characteristics, so that the same visual content would be shown differently (e.g., color vs. black/white, or high resolution vs. lower resolution) at various mobile devices depending on the conditions of display size, battery status, computational capability, and so on. The user preference enables filtering, searching, and browsing so that the genre of user favorable content could be ranked and recorded.

The personalization issue for three-dimensional television (“3DTV”) has not been well studied yet, as 3DTV is a recent advance and deployment of 3D displays is in an early stage.

### SUMMARY

An example in accordance with the present disclosure includes a method for personalized video depth adjustment. The method includes receiving a video frame, obtaining a frame depth map based on the video frame, and determining content genre of the video frame by classifying content of the video frame into one or more categories. The method also includes identifying a user viewing the video frame, retrieving depth preference information for the user from a user database, and deriving depth adjustment parameters based on the content genre and the depth preference information for the user. The method further includes adjusting the frame depth map based on the depth adjustment parameters, and providing a 3D video frame for display at a real-time playback rate on a user device of the user. The 3D video frame is generated based on the adjusted frame depth map.

Another example in accordance with the present disclosure includes a device coupled to receive a video frame. The device includes a depth map obtaining module to obtain a frame depth map based on the video frame, and a content classification module to determine content genre of the video frame by classifying content of the video frame into one or more categories. The device also includes a user detection module to identify a user viewing the video frame, and an analysis module to derive depth adjustment parameters based on the content genre and the user's depth preference information retrieved from a user database. The device further includes an automatic depth adjustment module to adjust the frame depth map based on the depth adjustment parameters, and a rendering engine to provide a 3D video frame for display at a real-time playback rate. The 3D video frame is generated based on the adjusted frame depth map.

It is to be understood that both the foregoing general description and the following detailed description are exemplary and explanatory only and are not restrictive of the invention, as claimed.

### BRIEF DESCRIPTION OF THE DRAWINGS

FIG. 1 illustrates a block diagram of an exemplary system.

FIG. 2 is a block diagram illustrating an embodiment of the exemplary system of FIG. 1.

FIG. 3 is a functional diagram illustrating an exemplary process flow in the embodiment of FIG. 2.

FIG. 4 illustrates an exemplary process flow of real-time personalization of 3DTV viewing experience.

FIG. 5 is a flowchart representing an exemplary method of frame depth map generation and video content classification.

FIG. 6 is a flowchart representing an exemplary method of personalized depth adjustment.

FIG. 7 is a flowchart representing an exemplary method of retrieval of user depth preference information.

### DETAILED DESCRIPTION

Reference will now be made in detail to the exemplary embodiments, examples of which are illustrated in the accompanying drawings. Wherever possible, the same reference numbers will be used throughout the drawings to refer to the same or like parts.

Exemplary embodiments disclosed herein are directed to methods and systems for 3DTV personalization, which dynamically adjusts depths of objects in a scene to satisfy a user's depth perception. The user's perception of 3D content is related to a depth structure of the scene, which is also reflected by disparity maps of a left/right view. The user's depth sensation might be different for different persons, content, display size, image resolution and viewing distances, but the depth sensation is constant for the same user for similar viewing conditions. In some embodiments, a user interactive depth mapping algorithm can be utilized to help adjust a depth map of a scene, and a specified depth can be entered via an on-line learning mechanism to update a user database. With the user database, systems disclosed herein can dynamically adjust the depth map of a scene according to playback content to satisfy the user's preference. In some embodiments, the disclosed systems can handle a multi-user scenario as well.

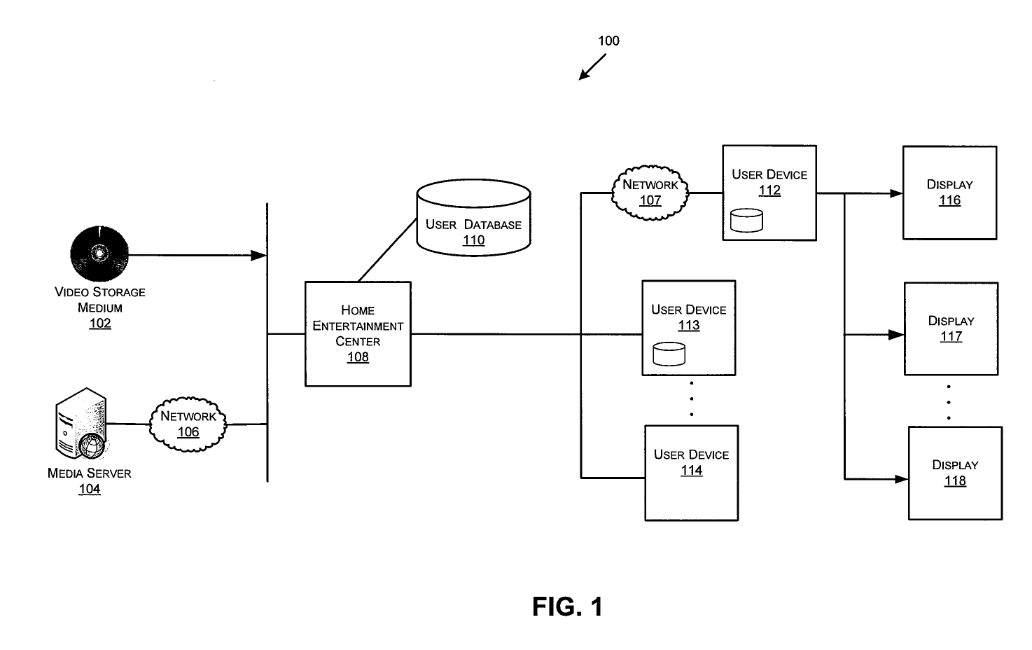

FIG. 1 illustrates a block diagram of an exemplary system 100. Exemplary system 100 can be any type of system that provides video content over a local connection or a network, such as a wireless network, Internet, broadcast network, etc. Exemplary system 100 can include, among other things, 2D or 3D video content sources such as a video storage medium 102, a media server 104 and/or network 106, a home entertainment center 108, a user database 110, and one or more user devices 112-114. The one or more user devices, for example, user device 112 can be connected to home entertainment center 108 via a network 107, and can have one or more external displays 116-118. Each user device can also have a user database.

Video storage medium 102 can be any medium storing video content. For example, video storage medium 102 can be provided as a video CD, DVD, Blu-ray disc, hard disk, magnetic tape, flash memory card/drive, volatile or non-volatile memory, holographic data storage, and any other storage medium. Video storage medium 102 can be located within home entertainment center 108, local to home entertainment center 108, or remote from home entertainment center 108.

Media server 104 can be a computer server that receives a request for video content from home entertainment center 108, processes the request, and provides video content to home entertainment center 108 through, in some embodiments, network 106. For example, media server 104 can be a web server, an enterprise server, or any other type of computer server. Media server 104 can be a computer programmed to accept requests (e.g., HTTP, or other protocols that can initiate a video session) from home entertainment center 108 and to serve home entertainment center 108 with video content. Also, media server 104 can be a broadcasting facility, such as free-to-air, cable, satellite, and other broadcasting facility, for distributing digital or non-digital video content to home entertainment center 108 through, in some embodiments, network 106.

Networks 106 and 107 can include any combination of wide area networks (WANs), local area networks (LANs), or wireless networks suitable for packet-type communications, such as Internet communications, or broadcast networks suitable for distributing digital or non-digital video content.

Home entertainment center 108 is a hardware device such as a set-top box, a computer, a PDA, a cell phone, a laptop, a desktop, a VCR, a Laserdisc player, a DVD player, blue ray disc player, a broadcast tuner, or any electronic device capable of playing video and managing content playback for various devices. Home entertainment center 108 may include software applications that allow center 108 to communicate with and receive video content from a data network, e.g., network 106, or local video storage medium 102. Home entertainment center 108 may, by means of included software applications, transform received video content into digital format, if not already in digital format. Home entertainment center 108 may transmit video content to user devices 112-114. Home entertainment center 108 may also communicate with user devices 112-114 to share user depth preference information and update user database 110 with user profiles for those who consume the home entertainment system. In addition, home entertainment center 108 may synchronize user depth preference information stored in user database 110 with those stored in local user databases on user devices 112-114.

User database 110 is one or more hardware storage devices for storing structured collections of records or data of user depth preference information. The structured storage can be organized as a set of queues, a structured file, a relational database, an object-oriented database, or any other appropriate database. Computer software, such as a database management system, may be utilized to manage and provide access to the data stored in user database 110. User database 110 may be located within home entertainment center 108, local to home entertainment center 108, or remote from home entertainment center 108. Some of user devices 112-114 may have their own user databases storing user depth preference information. User database 110 may be synchronized with the user databases of user devices 112-114.

The user depth preference information stored in user database 110 and/or the user databases of user devices 112-114 may include, but is not limited to:

(1) Information about each user consuming the home entertainment system. For example, the information may include but is not limited to, the user's identification and group members if the user is a user group consisting of one or more individual users. The user's identification may include one or more of face pictures, recorded voices, a name entered by the user, and/or other information identifying the user.

(2) Information about user devices 112-114 and their displays. For example, the information may include, but is not limited to, display screen size, resolution, and other information about the devices and displays.

(3) Each user's depth preferences. The depth preferences can be configured by the user, or automatically generated based on the information about user devices 112-114 and their displays, information about video such as video content categories and video resolution, viewing distances, historic depth preferences, and other factors.

The depth preference information for each user may be stored in a lookup table. In the lookup table, the user's depth preferences may be searched and retrieved based on the information about the user, the information about user devices 112-114 and their displays, the information about the video, and/or viewing distances, etc.

User devices 112-114 are hardware devices such as computers, PDAs, cell phones, laptops, desktops, broadcast tuners such as standard or mobile television sets, or any electronic devices capable of playing video. User devices 112-114 may include software applications that allow the devices to communicate with and receive video content from home entertainment center 108. The communication may be through a data network e.g., network 107. User devices 112-114 may also include a software video player that allows the device to play video. Examples of software video players include Adobe Flash Video Player, Microsoft Windows Media Player, RealPlayer, or any other player application. Some of user devices 112-114 may be located local to home entertainment center 108, or remote from home entertainment center 108. If there is no home entertainment center 108 and there is only one user device at home, the user device itself can be home entertainment center 108. Further, some of user devices 112-114 can have user databases storing user depth preference information.

User devices 112-114 may have different capabilities. A device can be a normal 2D TV playback device, so it does not have the capability to playback 3DTV content in 3D mode. In some embodiments, a device can have powerful capabilities. For example, the device may be capable of detecting and/or recognizing a user with its digital camera or voice recognition utilities. It may also be capable of allowing the user's interactions to manually configure or specify his/her depth sensation preference, and dynamically adjust the depth sensation based on an automatic depth adjustment algorithm. The device may even have intelligence to model/learn the user's depth preference based on the user's manually configured preference and/or historic depth preference information in a user database.

In other embodiments, a device may not support the user interactions to manually configure or specify the customized depth preference information, but may dynamically adjust depth sensation by obtaining instructions from the home entertainment center, which ports updated user database and notifies which group of users is currently viewing a video program. The user detection task may be performed by other devices in the home entertainment system.

In still other embodiments, a device may support the user interactions to manually configure or specify the depth preference information, and may dynamically adjust the depth sensation according to video content being played.

Some of user devices 112-114, for example, user device 112, may have one or more displays 116-118. Displays 116-118 are display devices for presentation of video content. For example, displays 116-118 may be provided as television sets, computer monitors, projectors, or any other video display devices. Displays 116-118 may have different screen size and resolution. Displays 116-118 may be located within user device 112, local to user device 112, or remote from user device 112.

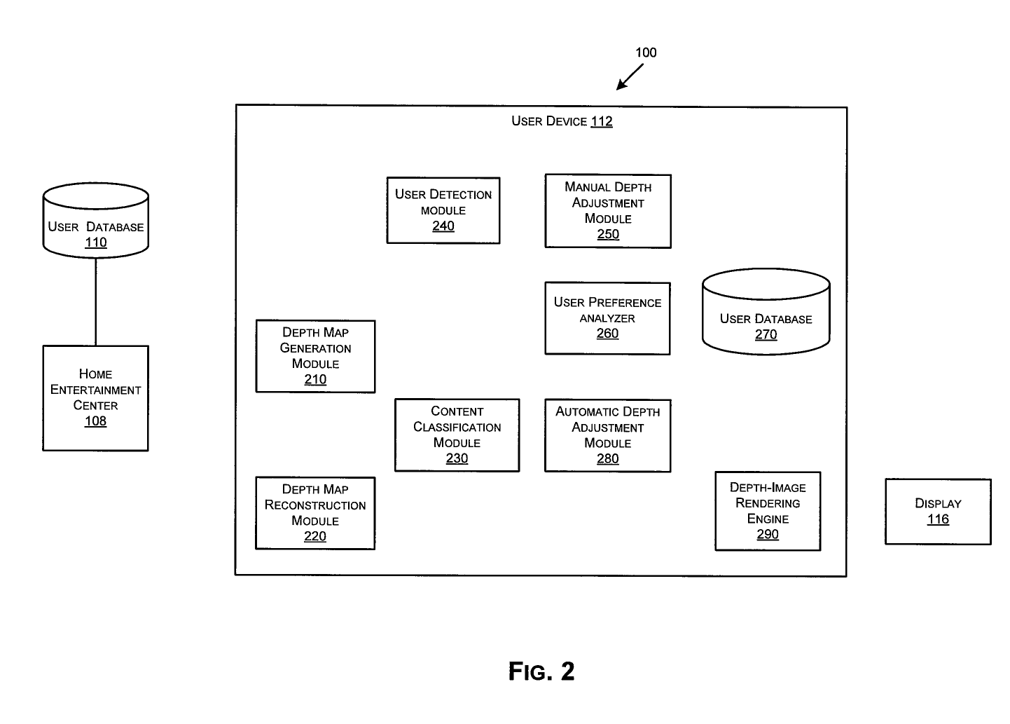

FIG. 2 is a block diagram illustrating user device 112 in greater detail within exemplary system 100. For simplicity, FIG. 2 only illustrates home entertainment center 108, user database 110, user device 112, and display 116. The illustrated configuration of user device 112 is exemplary only, and persons of ordinary skill in the art will appreciate that the various illustrated elements may be provided as discrete elements or be combined, and be provided as any combination of hardware and software.

With reference to FIG. 2, user device 112 includes a depth map generation module 210. Depth map generation module 210 can be a software program and/or a hardware device that generates 3D video depth maps from 2D video frames. The methods for generating the 3D video depth map may be, for example, methods for real-time 3D video depth map generation by background tracking and structure analysis. The methods may include receiving a 2D video frame having an original resolution, downscaling the decoded 2D video frame into an associated 2D video frame having a lower resolution, and segmenting objects present in the downscaled 2D video frame into background objects and foreground objects. The methods may also include generating a background depth map and a foreground depth map for the downscaled 2D video frame based on the segmented background and foreground objects, and deriving a frame depth map in the original resolution based on the background depth map and the foreground depth map.

For example, depth map generation module 210 may receive 2D video frames in original resolution (for example, 640-by-480), and downscale the 2D video frames into an associated set of lower-resolution frames (for example 240-by-135) for accelerated background tracking and depth map estimation. By tracking moving objects in the lower-resolution frames, module 210 may segment objects presented in each of the lower-resolution frames into the background and foreground objects. Next, the background and foreground objects are subjected to separate depth map estimation process.

Module 210 may generate a background depth map based on, among other things, background structure analysis and background depth map estimation. Various methods may be used in the background structure analysis. For example, such analysis may include detecting a vanishing point and vanishing lines of the background frame based on the segmented background objects. The vanishing point represents a most distant point from an observer, and the vanishing lines represent a direction of depth increase. The vanishing lines converge at the vanishing point. A region of the background frame having the greatest number of intersections is considered to be the vanishing point, and the main straight lines passing through or close to the vanishing point are considered to be vanishing lines. If no vanishing point is found, a default vanishing point, also referred to herein as a convergent point, on top of the background frame is used as the vanishing point and a default vanishing line is a vertical line running from top to bottom of the background frame and passing through the default vanishing point. Other methods known to those skilled in the art may also be used to determine the vanishing point and vanishing lines of the background.

Based on the information provided by background structure analysis, a background depth map may be derived. For example, with the detected vanishing point and the vanishing lines, module 210 may generate a depth map of the background accordingly. For example, module 210 may generate different depth gradient planes with the vanishing point being at the farthest distance and the vanishing lines indicating the direction of receding depth. Module 210 may then assign a depth level to every pixel on the depth gradient planes. Module 210 may additionally perform calibration steps, and finally derive the background depth map.

Also, module 210 may generate a foreground depth map based on, among other things, foreground skeleton depth estimation and foreground depth map estimation. Skeleton depth estimation includes object skeletonization. Such skeletonization may be performed by decomposing a foreground object shape into a skeleton defined as connected midpoints between two boundary points in the horizontal direction, and determining distances of the boundary points from the skeleton in the horizontal direction. The object boundary can be recovered from its skeleton and distance data. The skeleton points are connected in the vertical (y-axis) direction, which facilitates processing.

For foreground depth map estimation, it is assumed that a foreground object is typically oriented vertically within a scene, so that frontal skeleton points of the object have the same depth as a bottom point of the skeleton. To reduce computational complexity, module 210 may obtain the skeleton by scanning the foreground object and finding a middle point of the horizontal scan-line segment within the object. The bottom point of the skeleton is on the boundary of the foreground and background, and its depth was previously determined. Thus, module 210 may determine the depth of the bottom point of the skeleton based on the depth of its neighboring background, and determine the depth for all skeleton points because they have the same depth. Also, the depth of boundary points of the foreground object may be readily determined because the boundary points share the same depth with their neighboring background. The depth of the boundary points may be adjusted for a better 3D effect.

For each horizontal scan-line segment in the foreground object, with the depth for both the skeleton point (the middle point) and the boundary points having been determined, module 210 may interpolate internal points (between the skeleton point and the boundary points) on the scan-line segment with a Gaussian distribution function. For each internal point, two weights can be generated from the Gaussian function depending on the distances from the internal point to the skeleton point and to the boundary points. Module 210 may then derive the depth for the internal point through a non-linear interpolation process. Using this approach, the foreground thickness effect is enhanced to further strengthen the 3D depth effect. Based on the determined points and depths, module 210 may generate the foreground depth map.

Further, module 210 may derive a frame depth map for each video frame by fusing background and foreground depth maps in the original resolution. Module 210 may fuse the foreground and background depth maps in the original resolution and refines the depth continuity for the original resolution image. The frame depth map may be derived through an interpolation filtering process based on desired computational complexity. A variety of choices for interpolation may be used. For example, when implementing one solution to duplicate depths in the down-scaled map to result in an upscaled depth map having a higher resolution, a linear interpolation may be chosen to use a weighted average depth value from its neighboring pixels in the same scan-line to fill these positions in the upscaled depth map. More complicated filters such as bilinear or bicubic interpolation solutions may also be used. To achieve a better effect for a currently processed frame, module 210 may retrieve more than one neighboring 2D video frames in original resolution and their corresponding depth maps.

A depth map reconstruction module 220 can be provided as a software program and/or a hardware device to reconstruct or recover frame depth maps of the 3D video frames. Any disclosed depth map reconstruction method can be utilized by module 220. For example, depth map reconstruction may involve computational stereo for determining a 3D structure of a scene from two or more images taken from distinct viewpoints. A single 3D physical location projects to a unique pair of image locations in two observing cameras. As a result, given two camera images, if it is possible to locate the image locations that correspond to the same physical point in space, then it is possible to determine its three-dimensional location. Computational stereo may include calibration, correspondence, and reconstruction processes. The calibration process is for determining camera external geometry such as relative positions and orientations of each camera, and camera internal geometry such as focal lengths, optical centers, and lens distortions. The correspondence process is for determining the locations in each camera image that are the projection of the same physical point in space. The reconstruction process is for determining 3D structure from a dense disparity map based on known camera geometry by matching pixels in one image with their corresponding pixels in the other image.

A content classification module 230 can be provided as a software program and/or a hardware device to receive video frames and define a content genre by classifying the video frames into different categories. A user preference of the depth sensation may be highly correlated to the genre of the video content that the user is viewing. Therefore it may be useful for module 230 to automatically classify the video content into categories so that the user preference can be modeled progressively in response to more user interactions that personalize. For example, the content can be classified according to program type, such as drama, wildlife, sports, news, and so on. A specific program, for example, a sports program, can be further analyzed and broken down into semantic meaningful shots by grouping video frames into shots such as strokes in tennis video program. After that, low-level features, such as motion, color, human face, texture, and so on, may be used to further classify the content into additional categories.

Optionally, user device 112 may utilize a user detection module 240 for user detection and/or identification. User detection module 240 is a hardware device having a software program to detect and/or identify a user currently viewing a video program played on user device 112. The detection can be based on, for example, an image of the user's face, the user's voices, the user's interactions with user device 112, or other mechanisms. The software program at module 240 may identify the user based on vision-based face detection and recognition, speech recognition, or other algorithms. Also, user detection module 240 may receive the user's remote controller inputs, keypad inputs, or other interactions to detect and/or identify the user.

If module 240 identifies the user, it may retrieve the user's identification. If module 240 does not identify the user, it can create a new identification based on an image of the user's face, the user's voice, and/or the user's interactions with user device 112. In some embodiments, if user device 112 does not include module 240 or module 240 fails to identify the user, a default user can be identified as the current viewer. The default user can be, for example, the one using user device 112 most often. Further, user detection module 240 can be located within user device 112, local to user device 112, or remote from user device 112.

A manual depth adjustment module 250 may be provided as a software program and/or a hardware device to provide a user interface for the user to manually configure, such as by inputting or selecting, his/her depth preferences. The manually configured depth preferences may be associated with the user's identification and provided for depth adjustment, and may also be stored in user database 270. Depth adjustment is further described below.

A user preference analysis module 260 may be provided as a software program and/or a hardware device to derive depth adjustment parameters based on the user's historic depth preferences, information about user device 112 and display 116, the user's manually configured depth preferences, the content genre of the video content, viewing distances, and/or other information. After the user makes a final configuration of the preferred depth adjustment, module 260 utilizes a learning mechanism to study the user's inputs based on, for example, but not limited to, one or more of content information such as content category and content rendering resolution being currently viewed, current user viewing the content, information about display 116 such as screen size and resolution, and normalized translation and scaling parameters for depth adjustment.

User preference analysis module 260 may model the depth adjustment parameters with a mixture Gaussian model for each vector of content/user/display settings. Module 260 can model intensity values of each vector as a mixture of Gaussian distributions. In such case, each vector intensity is represented by a mixture of K (K is a pre-defined constant value) Gaussian distributions, and each Gaussian distribution is weighted according to the frequency with which it represents a certain cluster of parameters. Based on comparisons between distances from a current vector intensity value to means of the most influential Gaussian distributions and associated thresholds that are highly correlated to the standard deviations of Gaussian distributions, module 260 can determine to which cluster of parameters the vector of content/user/display settings corresponds.

User preference analysis module 260 may also utilize normalized translation and scaling parameters for depth adjustment. The normalized translation can be a function mapping one depth range to another depth range. For example, to adjust a depth range [10, 100] to [0, 200], a scaling function (to map the range distance from 90 to 200) plus a translation function (to map the starting point from 10 to 0) can be applied to achieve the desired result. User preference analysis module 260 may maintain a lookup table in a user database 270 for searching current depth adjustment parameters based on content/user/display settings. Automatic depth adjustment can be conducted with the depth adjustment parameters.

User device 112 may optionally include a user database 270 for storing a structured collection of records or data of users' depth preference information. The structured storage can be organized as a set of queues, a structured file, a relational database, an object-oriented database, or any other appropriate database. Computer software, such as a database management system, may be utilized to manage and provide access to the data stored in user database 270. User database 270 may be located within user device 112, local to user device 112, or remote from user device 112. User database 270 may be synchronized with user database 110 through home entertainment center 108.

An automatic depth adjustment module 280 may be provided as a software program and/or a hardware device to execute depth adjustment by changing frame depth maps for a current scene, which may include one or more video frames. During depth adjustment, whether manual or automatic, the scene depth structure may be maintained. Module 280, as well as module 250, may not change the depth order of the objects in the video frames. A user, through module 250, and/or module 280, may not micro-manage the scene by moving single objects in each frame because the task would become impractical for a typical movie with more than 15,000 frames. A depth map adjustment strategy disclosed herein is to map an object depth range in the scene to a new range with linear or non-linear mapping functions. For example, changing the depth range from [0, 1.0] to [0.2, 2.0] can push objects farther and increase the depth distances among objects. The mapping functions can strongly influence depth distances among objects as well. Non-linear functions (for the user's manual adjustment) can achieve uneven depth distances among objects and thus a predictable and controllable effect.

A depth-image rendering engine 290 may be a software program and/or a hardware device that receives adjusted frame depth maps and video frames and applies depth-image based rendering (“DIBR”) algorithms to generate multi-view video frames for 3D display. DIBR algorithms can produce a 3D representation based on images of an object and corresponding depth maps. To achieve a better 3D effect for a currently processed frame, depth-image rendering engine 290 may utilize one or more neighboring video frames and their adjusted depth maps.

DIBR algorithms may include 3D image warping. 3D image warping changes view direction and viewpoint of an object, and transforms pixels in a reference image of the object to a destination view in a 3D environment based on depth values of the pixels. A function can be used to map pixels from the reference image to the destination view. Depth-image rendering engine 290 may adjust and reconstruct the destination view to achieve a better effect.

DIBR algorithms may also include plenoptic image modeling. Plenoptic image modeling provides 3D scene information of an image visible from arbitrary viewpoints. The 3D scene information may be obtained by a function based on a set of reference images with depth information. These reference images are warped and combined to form 3D representations of the scene from a particular viewpoint. For an improved effect, depth-image rendering engine 290 may adjust and reconstruct the 3D scene information. Base on the 3D scene information, depth-image rendering engine 290 may generate multi-view video frames for 3D displaying.

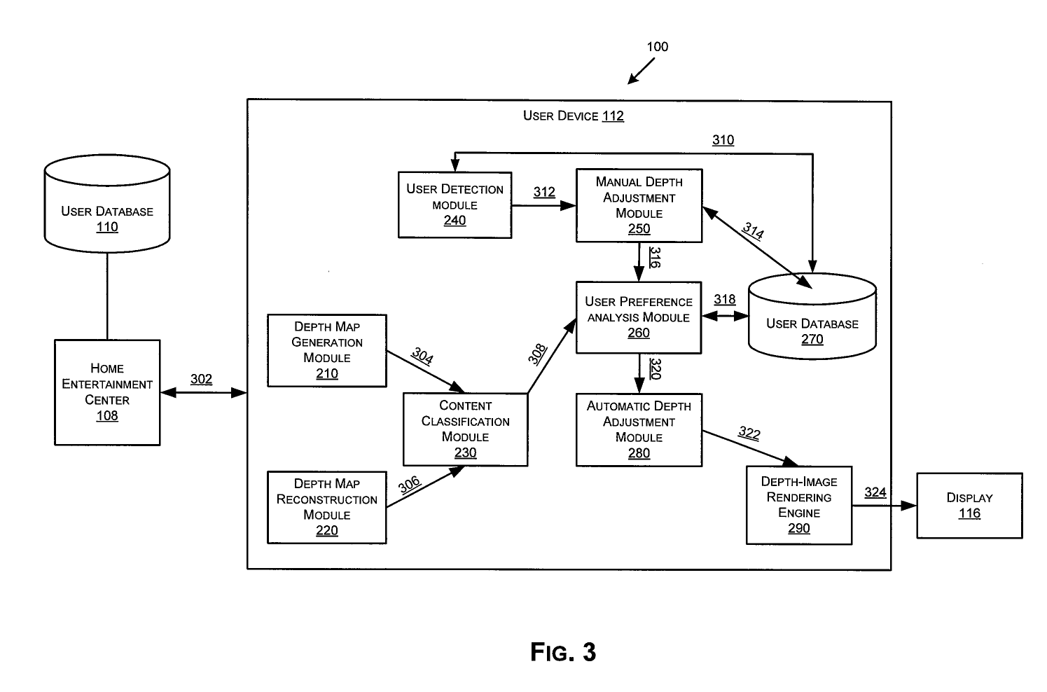

FIG. 3 is a functional diagram illustrating an exemplary process flow for personalizing 3DTV viewing experiences in exemplary system 100. It will now be appreciated by one of ordinary skill in the art that the illustrated process flow can be altered to delete steps, change the order of steps, or include additional steps.

After receiving (302), e.g., through network 107, video frames from home entertainment center 108, user device 112 can direct the video frames to different modules, depending on the format of the video frames. Each video frame can include a unique identifier (frame ID) for later retrieval and association purpose. In some embodiments, the video frames can be stored in a storage for later processing.

If the video frames are in 2D format, user device 112 may pass (not shown) the video frames to depth map generation module 210 to generate frame depth maps. After that, module 210 can transfer (304) the frame depth maps along with the associated video frames to content classification module 230.

If the video frames are in 3D format, user device 112 may pass (not shown) the video frames to depth map reconstruction module 220 to reconstruct or recover frame depth maps. After that, module 220 can transfer (306) the frame depth maps along with the associated video frames to content classification module 230.

Alternatively, the depth map generation/reconstruction and the content classification may be performed in a parallel manner. For example, user device 112 can transfer the video frames to module 210 or 220 for depth map generation or reconstruction, and to module 230 for content classification. The generated or reconstructed frame depth maps are associated with the corresponding video frames. The association may be based on the frame IDs. In some embodiments, the generated or reconstructed frame depth maps may be stored in association with the video frames in a storage for later processing.

After receiving (302, 304, or 306) the video frames, content classification module 230 may determine content genre based on content classification. The content genre is associated with the video frames. The association may be based on the frame IDs. In some embodiments, the content genre may be stored in association with the video frames in a storage for later processing. Content classification module 230 provides (308) the content genre for further processing.

If a user detection module 240 is available, module 240 may detect a user currently viewing video program, identify the user, and/or obtain the user identification. User detection module 240 may query user database 270 to identify the user and determine the user identification, and provide (312) the user identification to module 250. In some embodiments, module 240 may not be available to user device 112 but may be available to home entertainment center 108. In that case, module 240 may query user database 110 to identify the user and determine the user identification. Home entertainment center 108 may then send (302) the user identification to user device 112.

The identified user may specify his/her depth preferences about the video frames being viewed, through manual depth adjustment module 250. Module 250 may retrieve (314) his/her historic depth preferences and provide them to the user for selection or modification. Based on video content such as genre and resolution, information about user device 112 and display 116 such as screen size and resolution, and historic personal depth preferences, the user may manually input depth preferences or select from one of historic depth preferences. Module 250 may also provide linear or non-linear depth mapping functions for the user to map a depth range to another depth range. After the user inputs or selects depth preference, module 250 provides (316) the user's inputs or selection to module 260. Also, module 250 may store (314) the user's inputs or selection in association with the user identification in user database 270.

User preference analysis module 260 derives depth adjustment parameters based on information provided by modules 210, 220, 230, 250, and user database 270. Module 260 may retrieve (318) from user database 270 the user's historic depth preferences and information about user device 112 and display 116. Module 260 may also receive (308) from modules 210, 220, and/or 230 the video frames, frame depth maps, and video content information such as content genre and resolution. Further, module 260 may receive (316) from module 250 the user's manually entered or selected depth preferences. Alternatively, the information from other modules may be stored in one or more storages and module 260 may retrieve the information from the storages. After having derived the depth adjustment parameters, module 260 may provide (320) the parameters to module 280. In addition, module 260 may store (318) the derived depth adjustment parameters in association with the user identification in user database 270. Further, module 280 may update (318) the user depth preference information in user database 270 based on the user's manually configured depth preferences and/or the derived depth adjustment parameters.

In some embodiments, user device 112 does not include user database 270. In that case, user device 112 may obtain/store (302) the user depth preference information from/in user database 110 through home entertainment center 108.

After receiving (320) the depth adjustment parameters, automatic depth adjustment module 280 applies the parameters to the generated/reconstructed frame depth maps of the video frames to generate adjusted frame depth maps. Then, module 280 provides (322) the adjusted frame depth maps to depth-image rendering engine 290.

Based on the adjusted frame depth map and the corresponding video frames received (320) or retrieved from a storage, depth-image rendering engine 290 applies DIBR algorithms to generate multi-view (3D) video frames with adjusted 3D effects, as described above. To achieve a desired 3D effect for a currently processed frame, depth-image rendering engine 290 may adjust the 3D video frame based on one or more neighboring video frames and their corresponding adjusted depth maps. Depth-image rendering engine 290 provides (324) the generated video frames to display 116 for 3D displaying.

The systems and methods disclosed herein can also handle multi-user scenario. In some embodiments, a user may be a user group including one or more individual viewers. If the user is a user group, modules involving the user's information, such as modules 240, 250, 260, 270, and 280 and database 270, work in similar ways to that for an individual viewer. Information for the user group can be retrieved, processed, and stored in similar ways to that for an individual viewer.

Moreover, an individual viewer's depth preference information can be obtained based on the group's depth preference information. The basic assumption is that a final depth inputs/selection for a user group would be tolerable for all viewers in the group, but this inputs/selection would be counted in a low-weighted manner in the training process as it may not reflect the best choice for each viewer in the user group. The user group's inputs can be mainly valuable for a member user who has few statistics, e.g., historic depth preferences, in user database 270. This user may choose not to manually configure his/her depth preferences. The user group's inputs/selection may be the only information available to determine this user's depth preferences.

Furthermore, this user may be a member of several user groups, and this user's depth preferences may be obtained by, for example, a weighted sum based on each user group's depth preferences and the user's participation in determining the group's depth preferences, because the statistics show that this user is not so sensitive to the depth sensation. For example, user A may be a member of group I consisting of users A, B, and C, a member of group II consisting of users A, D, and E, and a member of group III consisting of users A and F. User A's depth preferences can be obtained by a weighted sum, which can be determined, for example, by summing group I's depth preferences times ⅓ (user A equally participated in determining the group's depth preference with other group members), group II's depth preferences times ⅓ (user A equally participated in determining the group's depth preference with other group members), and group III's depth preferences times ⅓ (user A did not actively participate in determining the group's depth preference as the other group member did).

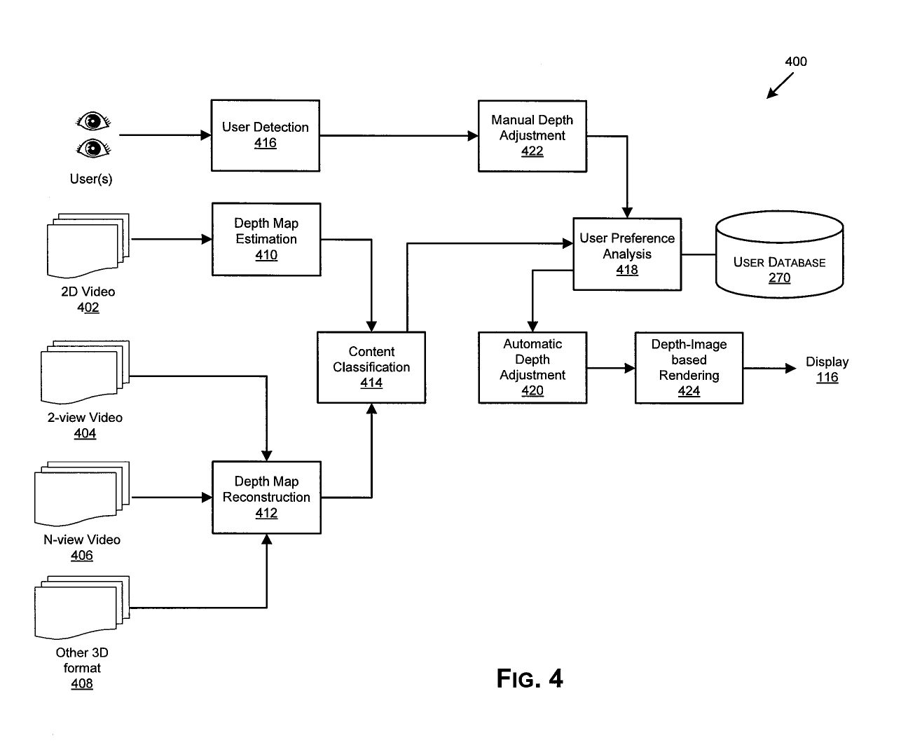

FIG. 4 illustrates an exemplary process flow 400 of personalizing 3DTV viewing experiences. It will now be appreciated by one of ordinary skill in the art that the illustrated process can be altered to delete steps, change the order of steps, or include additional steps.

Incoming video content received by a user device could be either in a 2D format (402) or in a 3D format (404, 406, and 408). For the former case, the user device can perform depth map estimation (410) to generate frame depth maps during a 2D-to-3D conversion process. For the latter case, a depth map reconstruction process (412) is called. In the meantime, the 2D or 3D video content can be processed (414) by the content classification module 230 to define its genre.

The viewer information, such as a user or user group identification, can be obtained through user detection (416). For example, the viewer information can be obtained either by a video camera for automatic detection, or by the user or user group's inputs. Otherwise, a default user or user group, for example, the one with the greatest frequency of using the system, can be identified as the current viewer.

A user preference analysis process (418) determines the best setting for the current viewer according to content genre and resolution, viewing condition such as display size and resolution retrieved from user database 270, view distances, and other information. The user device may then perform automatic depth adjustment (420) to execute the setting of depth preference by changing the frame depth maps for current scene, which may include one or more video frames.

On the other hand, when the user or user group decides to intervene the depth adjustment process, the user or user group can use a user interface to perform manual depth adjustment (422) to specify a desired depth sensation. The user device may perform user preference analysis on the user or user group's request, update the user or user group's depth preferences with a learning mechanism, and store the updated depth preferences in user database 270. In addition, the user device may apply the automatic depth adjustment (420) based on the user or user group's request.

Finally, the user device may apply a depth-image-based rendering algorithm (424) to the video scene based on the adjusted frame depth maps, and render the 3D scene into a number of views for displaying (116).

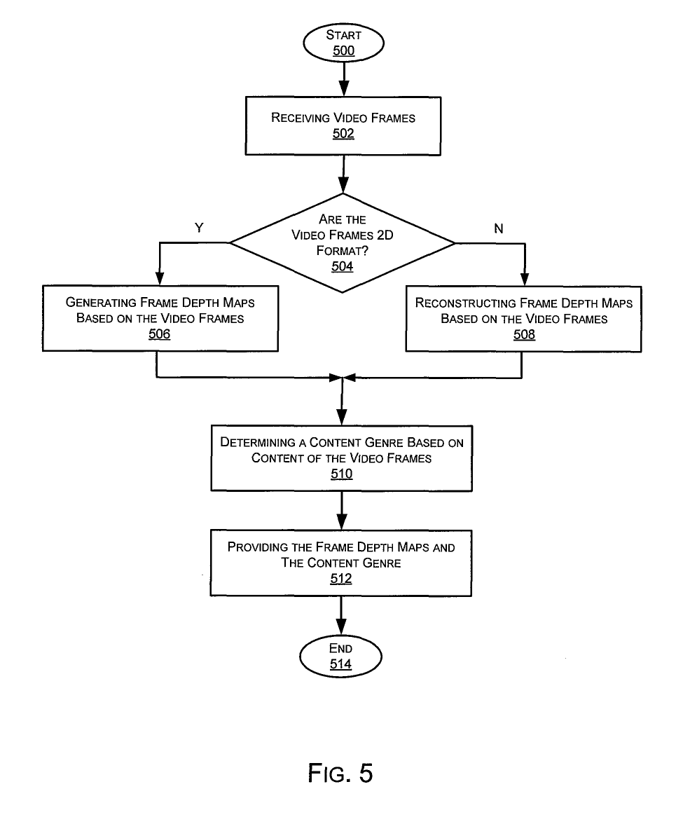

FIG. 5 is a flowchart representing an exemplary method of frame depth map generation and video content classification. It will now be appreciated by one of ordinary skill in the art that the illustrated procedure can be altered to delete steps, change the order of steps, or include additional steps. After an initial start step 500, user device 112 receives (502) one or more video frames from, for example, home entertainment center 108. Then, user device 112 determines (504) whether the video frames are in a 2D format or a 3D format.

If the video frames are in a 2D format (504-yes), depth map generation module 210 of user device 112 generates (506) frame depth maps based on the video frames. If the video frames are in a 3D format (504-no), depth map reconstruction module 220 of user device 112 reconstructs (508) frame depth maps based on the video frames.

After receiving (502) the video frames, content classification module 240 of user device 112 determines (510) a content genre based on content classification of the video frames. The content genre can include one or more content categories based on one or more levels of classification. Alternatively, steps 506 and 510 or steps 508 and 510 can be performed in a parallel manner. Also, the received video frames, the generated or reconstructed frame depth maps, and the content genre can be stored in one or more storages for later processing and retrieval. User device 112 provides (512) the generated or reconstructed frame depth maps and the content genre for further processing. The method then ends (514).

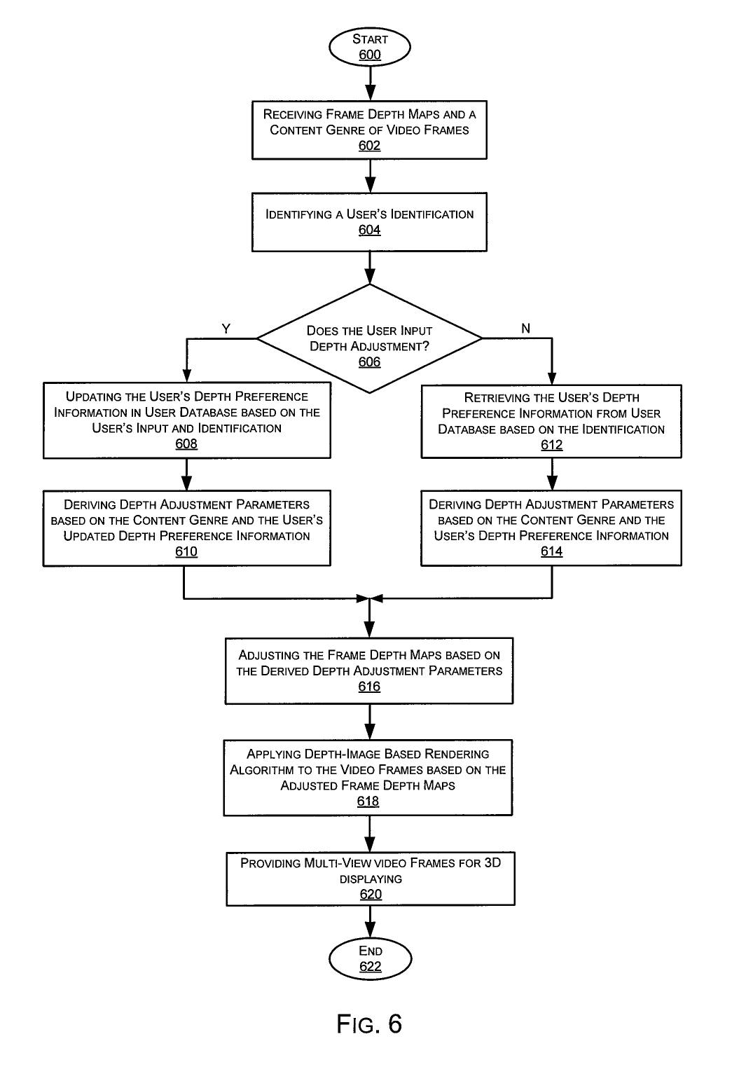

FIG. 6 is a flowchart representing an exemplary method of personalized depth adjustment. It will now be appreciated by one of ordinary skill in the art that the illustrated procedure can be altered to delete steps, change the order of steps, or include additional steps. After an initial start step 600, user preference analysis module 260 of user device 112 receives (602) video frames, generated or reconstructed frame depth maps, and a content genre of the video frames.

If available, user detection module 230 of user device 112 detects and/or identifies (604) a user or user group currently viewing the video frames, and retrieves (604) the user or user group's identification from user database 270 of user device 112. In some embodiments, module 230 may be not available to user device 112, and user device 112 may be able to obtain the user or user group's identification from user database 110 through home entertainment center 108. In other embodiments, if user database 270 is not available or module 230 cannot recognize the user or user group, a default user or user group's identification can be used.

Manual depth adjustment module 250 determines (606) whether the user or user group manually inputs depth adjustment information. If yes (606-yes), user preference analysis module 260 of user device 112 updates (608) the user or user group's depth preference information in user database 270 of user device 112 based on the manual inputs. At this point in the method an optional verification can be performed. A user may adjust depth, try it for a while, and not be satisfied. Module 260 may update the user or user group's depth preference information in user database 270 if the user is satisfied with the perceived depth after viewing either for some period of time without modifying the adjustment, or via interactive verification. Then, module 260 can utilize a learning mechanism to derive (610) depth adjustment parameters based on the content genre, the video frame's resolution, the user or user group's updated depth preference information, and other information such as a viewing distance. The user or user group's updated depth preference information can include, but is not limited to, for example, user device 112's configurations, display screen size and resolution, the user or user group's manually inputted depth adjustment information, the user or user group's historic depth preferences based on content/user/display settings, and so on.

If the user or user group does not manually input depth adjustment information (606-no), user preference analysis module 260 of user device 112 can retrieve (612) the user or user group's depth preference information from user database 270 of user device 112 based on the identification. If user device 112 does not have user database 270, user device 112 can obtain the user or user group's depth preference information from user database 110 through home entertainment center 108. Module 260 can derive (614) depth adjustment parameters based on the content genre, the video frame's resolution, the user or user group's depth preference information, and other information such as a viewing distance. The user or user group's depth preference information can include but not limited to, for example, user device 112's configurations, display screen size and resolution, the user or user group's historic depth preferences based on content/user/display settings, and so on.

Automatic depth adjustment module 280 of user device 112 adjusts (616) the frame depth maps of the video frames based on the derived depth adjustment parameters. Then, depth-image rendering engine 290 of user device 112 can apply (618) depth image based rendering algorithms to the video frames based on the adjusted frame depth maps, and provide (620) multi-view video frames for 3D displaying. The method then ends (622).

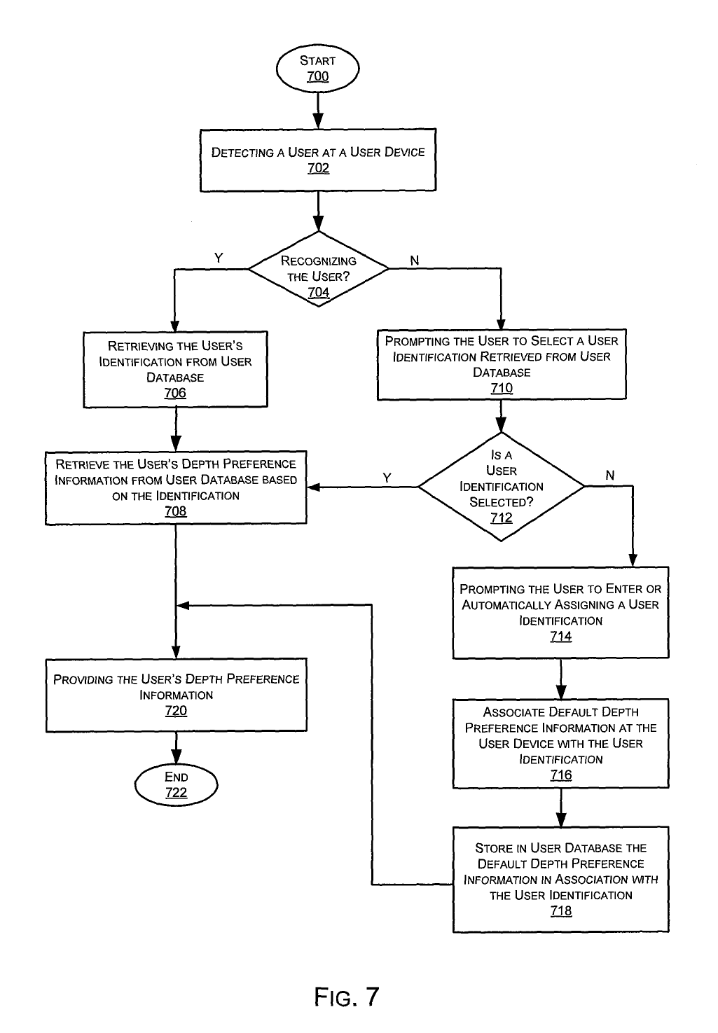

FIG. 7 is a flowchart representing an exemplary method of retrieval of user depth preference information. It will now be appreciated by one of ordinary skill in the art that the illustrated procedure can be altered to delete steps, change the order of steps, or include additional steps. After initial start step 700, user detection module 240 of user device 112 detects (702) a user or user group who is viewing video frames at user device 112.

If recognizing the user or user group (704-yes), user detection module 240 can retrieve (706) the user or user group's identification from user database 270 of user device 112. Based on the user or user group's identification, user preference analysis module 260 of user device 112 can retrieve (708) the user or user group's depth preference information from user database 270 of user device 112.

If not recognizing the user or user group (704-no), user detection module 240 of user device 112 can prompt (710) the user or user group to select a user identification retrieved from user database 270 of user device 112. If an identification is selected (712-yes), user preference analysis module 260 of user device 112 can retrieve (708) the user or user group's depth preference information from user database 270 of user device 112.

If an identification is not selected (712-no), it may be the first time for the user or user group to use user device 112. User detection module 240 can prompt (714) the user or user group to enter an identification, or module 240 can automatically assign (714) an identification based on the user or user group's face pictures, voices, and/or other information. Module 240 can also treat the user or user group as a default user or user group who uses user device 112 most often, and assign (714) the user or user group a default identification. User preference analysis module 260 of user device 112 can associate (716) default or generally accepted depth preference information with the user or user group's identification, and store (718) in user database 270 of user device 112 the default depth preference information in association with the user or user group's assigned identification.

In some embodiments, user database 270 may not be available to user device 112. In such embodiments, user device 112 may obtain information from and/or store information in user database 110 through home entertainment center 108. In other embodiments, user detection 240 may be available to home entertainment center 108 but not available to user device 112. In such embodiments, user device 112 may obtain the user or user group's identification and depth preference information from user database 110 through home entertainment center 108.

User preference analysis module 260 of user device 112 provides (720) the user or user group's depth preference information for further processing. The method then ends (722).

In some embodiments, a portion or all of the methods disclosed herein may also be performed by a device that is different from user device 112, and is located local to or remote from user device 112.

The methods disclosed herein may be implemented as a computer program product, i.e., a computer program tangibly embodied in an information carrier, e.g., in a machine readable storage device, for execution by, or to control the operation of, data processing apparatus, e.g., a programmable processor, a computer, or multiple computers. A computer program can be written in any form of programming language, including compiled or interpreted languages, and it can be deployed in any form, including as a standalone program or as a module, component, subroutine, or other unit suitable for use in a computing environment. A computer program can be deployed to be executed on one computer or on multiple computers at one site or distributed across multiple sites and interconnected by a communication network.

A portion or all of the methods disclosed herein may also be implemented by an application specific integrated circuit (ASIC), a field-programmable gate array (FPGA), a complex programmable logic device (CPLD), a printed circuit board (PCB), a digital signal processor (DSP), a combination of programmable logic components and programmable interconnects, a single central processing unit (CPU) chip, a CPU chip combined on a motherboard, a general purpose computer, or any other combination of devices or modules capable of performing personalized depth adjustment disclosed herein.

In the preceding specification, the invention has been described with reference to specific exemplary embodiments. It will, however, be evident that various modifications and changes may be made without departing from the broader spirit and scope of the invention as set forth in the claims that follow. The specification and drawings are accordingly to be regarded as illustrative rather than restrictive. Other embodiments of the invention may be apparent to those skilled in the art from consideration of the specification and practice of the invention disclosed herein.

What is claimed is:

1. A computer-implemented method for personalized video depth adjustment, comprising:
receiving a video frame;
obtaining a frame depth map based on the video frame;
determining content genre of the video frame by classifying content of the video frame into one or more categories;
identifying a user viewing the video frame;
retrieving depth preference information for the user from a user database;
deriving depth adjustment parameters based on the content genre and the depth preference information for the user;
adjusting the frame depth map based on the depth adjustment parameters; and
providing a 3D video frame for display at a real-time playback rate on a user device of the user, wherein the 3D video frame is generated based on the adjusted frame depth map.

2. The method of claim 1, wherein the obtaining the frame depth map comprises:
generating, if the video frame is in a 2D format, the frame depth map from the 2D video frame; and
reconstructing, if the video frame is in a 3D format, the frame depth map from the 3D video frame.

3. The method of claim 1, further comprising determining the depth preference information for the user, which includes:
identifying information about the user, which includes an identification of the user and group members if the user is a user group having one or more individual users;
identifying information about the user device, which includes display screen size and/or resolution; and
identifying depth preferences for the user,
wherein the information about the user device and the depth preferences for the user are associated with the information about the user.

4. The method of claim 1, wherein the identifying the user comprises:
recognizing the user based on a user identification distinguishing the user from other users who have used the user device to view a video program,
wherein the user identification includes one or more of an image of a face of the user, a voice of the user, and/or a name of the user inputted by the user.

5. The method of claim 1, wherein the identifying the user comprises:
treating the user as a default user who uses the user device most often, if the user cannot be identified.

6. The method of claim 1, wherein the identifying the user comprises:
identifying the user as a group of one or more individual users.

7. The method of claim 6, wherein the user is a member of one or more user groups each including one or more individual users, the identifying the user comprising:
identifying the one or more user groups to which the user belongs.

8. The method of claim 6, wherein the user is a member of one or more user groups each including one or more individual users, the retrieving the depth preference information comprises:
retrieving depth preference information for the one or more user groups; and
obtaining the depth preference information for the user based on the depth preference information for the one or more user groups.

9. The method of claim 1, further comprising:
providing a user interface for the user to manually configure a depth preference; and
updating the depth preference information for the user in the user database based on the manually configured depth preference, after the user has verified satisfaction with the manually configured depth preference.

10. The method of claim 9, further comprising:
deriving the depth adjustment parameters based on the content genre and the manually configured depth preference.

11. The method of claim 1, further comprising:
updating the depth preference information for the user in the user database based on the depth adjustment parameters.

12. A device coupled to receive a video frame, the device comprising:
a depth map obtaining module to obtain a frame depth map based on the video frame;
a content classification module to determine content genre of the video frame by classifying content of the video frame into one or more categories;
a user detection module to identify a user viewing the video frame;
an analysis module to derive depth adjustment parameters based on the content genre and the user's depth preference information retrieved from a user database;
an automatic depth adjustment module to adjust the frame depth map based on the depth adjustment parameters; and
a rendering engine to provide a 3D video frame for display at a real-time playback rate, wherein the 3D video frame is generated based on the adjusted frame depth map.

13. The device of claim 12, wherein the depth map obtaining module comprises:
a depth map generation module to generate, if the video frame is in a 2D format, the frame depth map from the 2D video frame; and
a depth map reconstruction module to reconstruct, if the video frame is in a 3D format, the frame depth map from the 3D video frame.

14. The device of claim 12, wherein the user detection module comprises one or more of:
a vision-based face detection and recognition module to detect and recognize the user based on an image of a face of the user;
a speech detection and recognition module to detect and recognize the user based on a voice of the user; and
a manual input module to accept manual inputs of the user through a remote controller or a keypad and to recognize the user based on the manual inputs.

15. The device of claim 12, wherein the user detection module is configured to:
identify the user as a user group including one or more individual users.

16. The device of claim 12, wherein the user detection module is configured to:
identify one or more user groups to which the user belongs, wherein the user is a member of the one or more user groups each including one or more individual users.

17. The device of claim 12, wherein the analysis module is configured to:
retrieve the depth preference information for one or more user groups, wherein the user is a member of the one or more user groups each including one or more individual users; and
obtain the depth preference information for the user based on the depth preference information for the one or more user groups.

18. The device of claim 12, wherein the user database is configured to store the depth preference information for the user, and
the depth preference information for the user includes identification of the user and group members if the user is a user group, display information including at least of display screen size and resolution, and historic depth preferences manually configured by the user or automatically generated.

19. The device of claim 12, further comprising:
a manual depth adjustment module to provide a user interface for the user to manually configure a depth preference.

20. The device of claim 19, wherein the manual depth adjustment module is configured to:
update the depth preference information for the user in the user database based on the manually configured depth preference, after the user has verified satisfaction with the manually configured depth preference.

21. The device of claim 20, wherein the analysis module is configured to:
derive the depth adjustment parameters based on the content genre and the updated depth preference information.

22. The device of claim 12, wherein the analysis module is configured to:
update the depth preference information for the user in the user database based on the depth adjustment parameters.

23. A computer readable medium storing instructions that, when executed, cause a computer to perform a method for personalized video depth adjustment, the method comprising:
receiving a video frame;
obtaining a frame depth map based on the video frame;
determining content genre of the video frame by classifying content of the video frame into one or more categories;
identifying a user viewing the video frame;
retrieving depth preference information for the user from a user database;
deriving depth adjustment parameters based on the content genre and the depth preference information for the user;
adjusting the frame depth map based on the depth adjustment parameters; and
providing a 3D video frame for display at a real-time playback rate on a user device of the user, wherein the 3D video frame is generated based on the adjusted frame depth map.
